(19) United States
(12) Patent Application Publication
(10) Pub. No.: US 2004/0246195 A1
(43) Pub. Date: Dec. 9, 2004

(54) Radome

(75) Inventors: Ryo Usami, Tokyo (JP); Tsuyoshi Ozaki, Tokyo (JP); Jun Tsuruta, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/724,746

(22) Filed: Dec. 2, 2003

(30) Foreign Application Priority Data
Jun. 9, 2003 (JP) 2003-164107

(51) Int. Cl. H01Q 1/42

(52) U.S. Cl. 343/872

(57) ABSTRACT

A radome has a structure in which respective skin portions are laminated to an internal surface and an external surface of a core portion, respectively, and the surface of the skin portion laminated to the external surface thereof is coated with a coating material. The radome accommodates an antenna. A material is dispersed in the two skin portions or the core portion, or in both the two skin portions and the core portion. The material has a relative dielectric constant that is different from the portion in which the material is dispersed, thereby adjusting the difference between the relative dielectric constants of the skin portions and the core portion to no more than 1.5.

### BACKGROUND OF THE INVENTION

1. Field of the Invention

The present invention relates to a radome that accommodates a radar, and more particularly the invention relates to a radome that is installed in an aircraft, a vehicle, or the like, and that has an aerodynamic shape.

2. Description of the Related Art

With recent improvements in communication technology and information processing technology, a technology for two-way communicating from an aircraft, a vehicle, or the like is being placed in practical use. Particularly for the aircraft, in order to communicate from an installed antenna system therein through the medium of satellites, a wider beam scanning range than the conventional is demanded. Therefore, it is required of the radome that the reflection loss of an electromagnetic wave, which is caused by the reflection of the wave input and output through the antenna on the wall of the radome, be kept small over the wider range of the antenna scanning angle.

In general, in a radome that accommodates an antenna, as the scanning angle at which the antenna inputs and outputs an electromagnetic wave changes, the angle of incidence at which the electromagnetic wave impinges on the wall of the radome changes. In a radome having an aerodynamic shape in contrast to a ground radome having a hemispherical shape, the angle of incidence of the electromagnetic wave on the wall of the radome is not uniform. Generally, when the electromagnetic wave impinges on the wall of the radome at a large angle to the wall, the reflection loss thereof becomes large. For this reason, in order to lower the reflection loss at a wider scanning angle of the antenna, it is requested that the reflection loss of the electromagnetic wave be kept small at a wider angle of incidence of the electromagnetic wave on the wall of the radome.

A radome for an aircraft, for instance, is usually produced such that the radome has a sandwich structure obtained by placing a core portion (material) between skin portions (materials) and laminating these materials. For instance, “The Handbook of Antenna Engineering” (edited by IEICE (The Institute of Electronics, Information and Communication Engineers), published by Ohm Company, Oct. 30, 1980, pp. 301) describes a radome conventionally produced by sandwiching and binding a core portion having a low relative dielectric constant between skin portions having a high relative dielectric constant in order to reduce the reflection loss.

In addition, Japanese Patent Publication JP-A2002-299938, for instance, discloses a radome for an aircraft, composed of skin portions and a core portion such that the difference in relative dielectric constant therebetween is 2.0 at lowest. This is because a core portion having a low relative dielectric constant is used in a conventional radome for an aircraft.

By the way, itis required of the radome mounted on an aircraft that its dielectric characteristics and mechanical strength for withstanding aerodynamic force be mutually compatible. From this viewpoint, U.S. Pat. No. 5,936,025, for instance, discloses a technology that uses a composite material consisting of a ceramic powder and a resin, limited by a mixture of TiO₂ and a cyanate resin in order to adjust the dielectric characteristics of the radome.

However, when a radome having a laminated structure composed of skin portions and a core portion is constructed according to the conventional technologies, the reflection of an electromagnetic wave resulting from the difference in relative dielectric constant between the skin portion and the core portion occurs at an interface therebetween because the difference in relative dielectric constant between the skin portion and the core portion is large. Thus, there is the problem that the reflection loss becomes large in the radome. Because a radome installed on the top surface of an aircraft particularly has an aerodynamic shape so as to reduce the air resistance, the radome has a drawback that the angle of incidence of the electromagnetic wave on the wall of the radome is large. Consequently, there is the problem that the loss of the electromagnetic wave becomes further large in such a radome.

On the other hand, when the electromagnetic wave impinges at a large angle of incidence on the wall of the radome in which the difference in relative dielectric constant between the skin portion and the core portion is large, the reflection loss may increased is advantageously extremely. For these reasons, there is the problem that the radome having an aerodynamic shape, produced according to the conventional technologies cannot obtain a sufficient antenna gain.

### SUMMARY OF THE INVENTION

The present invention has been accomplished to solve the above-mentioned problems. An object of the present invention is to provide a radome in which the reflection loss of an electromagnetic wave can be suppressed small even if the angle of incidence of the electromagnetic wave impinging on the radome is large.

The radome according to the present invention has a laminated structure consisting of skin portions and a core portion, and is composed of the skin portions and the core portion such that the difference in relative dielectric constant there between is 1.5 or less. Therefore, according to the present invention, the reflection loss of the electromagnetic wave can be lowered over the wide range of the angle of incidence.

### BRIEF DESCRIPTION OF THE DRAWINGS

FIG. 1 is a view for explaining the radome according to a first embodiment 1 of the present invention; and

FIG. 2 is a diagram for showing the dependence of the maximum angle of incidence at which a reflection loss smaller than 0.5 dB is obtained on the difference in relative dielectric constant between the skin portion and the core portion.

### DETAILED DESCRIPTION OF THE PREFERRED EMBODIMENTS

An embodiment of the present invention will be described below.

Embodiment 1

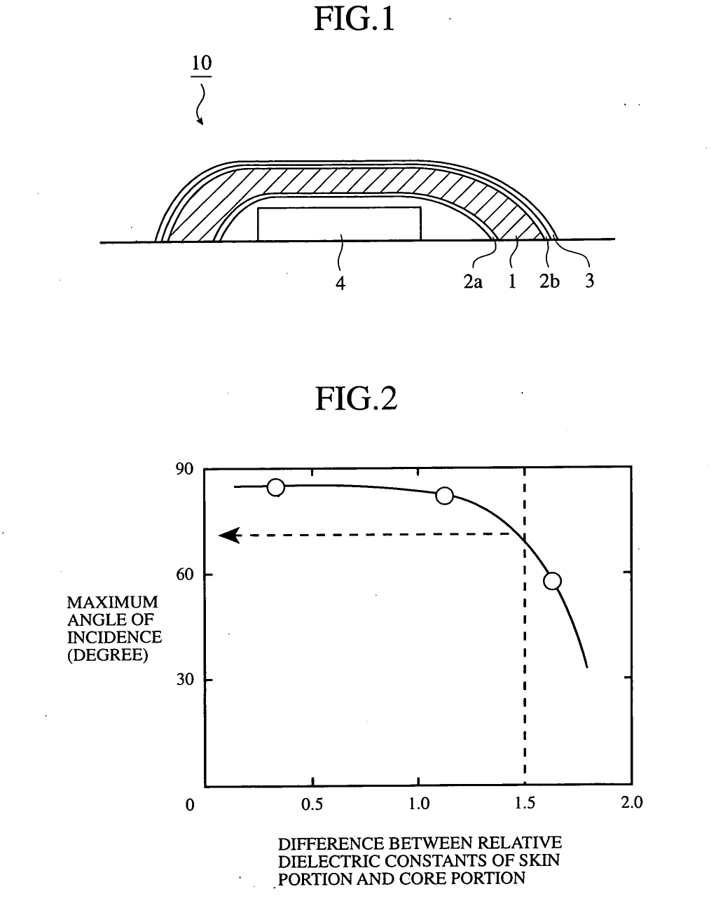

A radome 10 of a first embodiment in accordance with the present invention will be described with reference to FIG. 1 and FIG. 2. FIG. 1 is a view for explaining the radome 10 in accordance with the first embodiment, and it is a sectional view of the radome 10 that has an aerodynamic shape. FIG. 2 is a diagram for showing the dependence of the maximum angle of incidence which renders the reflection loss smaller than 0.5 dB, on the difference in relative dielectric constant between the skin portion and the core portion.

As shown in FIG. 1, the radome 10 has a structure in which a skin portion 2a and a skin portion 2b are laminated to the internal surface and the external surface of a core portion 1, respectively, and the surface of the skin portion 2b laminated to the external surface thereof is coated with a coating material 3. The radome 10 accommodates an antenna 4.

In order to produce the radome 10 having the laminated structure shown in FIG. 1, the following process, for instance, can be used.

Prepared is a prepreg that is a mixture consisting of reinforcing fiber such as quartz fiber and resin, and that is to be changed into the skin portions 2a, 2b after thermosetting. Meanwhile, a base material to be transformed into the core portion 1 after thermosetting is prepared by adding ceramic powder that is relative-dielectric-constant adjusting material to the main material of the core portion, then dispersing the powder in the main material of the core portion, and subsequently forming the obtained mixture into a sheet. The prepreg for the skin portion 2a, the base material for the core portion 1, and the prepreg for the skin portion 2b are stacked in this order over a molding die, and then these materials are subjected to thermosetting. After that, the surface of the skin portion 2b is coated with the coating material 3, so that the radome 10 can be formed.

The present inventors have studied thoroughly, and found that the reflection loss in a sandwich panel depends on the difference in relative dielectric constant between the two layers disposed immediately adjacent each other. One type of skin portion (material) and several types of core portions (materials, namely “base materials”) each having a different relative dielectric constant to each other, obtained by changing the amount of the ceramic powder to be added to the main material, are used, there by molding and obtaining several types of samples of sandwich panels each having a different difference in relative dielectric constant between the skin portion and the core portion.

The measurement of a transmission loss while making an electromagnetic wave impinge on the sample at an angle that is being changed showed that the transmission loss rapidly increases on each of the samples when the angle of incidence exceeded one value. The larger the angle of incidence at the time the transmission loss increased to 0.5 dB is, the better the material is for the radome. Therefore, the angles of incidence at the time the transmission loss became 0.5 db were plotted with respect to the difference of the relative dielectric constants, which gives the results shown in FIG. 2.

As is apparent from FIG. 2, when the difference in relative dielectric constant between the skin portion and the core portion is 1.5 or less, the angle of incidence is 70 degrees or more. Because an angle of 70 degrees is the maximum angle of incidence required of the radome that has an aerodynamic shape, it has become clear that when the difference in relative dielectric constant between the skin portion and the core portion is 1.5 or less, the radome can achieve high performance.

In the first embodiment, the application of the above-described result makes it possible to reduce the reflection loss in the radome by use of means described as below.

About the difference in relative dielectric constant between the layer of the skin portion 2b and the layer of the coating material 3, the adjustment of the mixing proportions of the reinforcing fiber and the resin that constitute the skin portion can make the difference between the skin portion 2b and the coating material 3 fall within the range of 1.5 or less.

About the differences in relative dielectric constant between the layer of the core portion 1 and the layers of the skin portion 2a and the skin portion 2b, the addition of a predetermined amount of the ceramic powder the principal ingredient of which is BaTiO₃, for instance, whose relative dielectric constant is 3,500 to the core portion (material), can make the differences between the core portion 1 and the skin portions 2a, 2b fall within the range of 1.5 or less.

As mentioned above, according to the first embodiment, the difference in relative dielectric constant between the skin portions and the core portion is adjusted to 1.5 or less, thereby making it possible to suppress the loss of the electromagnetic wave to less than 0.5 dB over the wide range of the angle of incidence of zero to 70 degrees or more.

In the first embodiment 1, quartz fiber, for instance, is used as the reinforcing fiber used for the skin portions 2a, 2b, but a similar effect can be also obtained when other reinforcing fibers are used.

In addition, in order to adjust the relative dielectric constant, the ceramic powder the principal ingredient of which is BaTiO₃ was added to the main material of the core portion. However, when anyone selected from the group consisting of BaTiO₃, CaTiO₃, MgTiO₃, SrTiO₃, (Zr, Sn)TiO₄, BaTi₄O₉, Ba₂Ti₉O₂₀, (Mg, Ca)TiO₃, Ba(Zr, Ti)O₃, Ba(Mg, Ta)O₃, Ba(Zn, Ta) O₃, BaTiO₄, WO₃, TiO₂, Bi₄Ti₃O₁₂, BaZrO₃, CaSnO₃, alumina, and silicon is added thereto, a similar effect can be also obtained.

Moreover, in one preferred embodiment of the present invention, in order to adjust the relative dielectric constant, TiO₂ that is one type of ceramic powder is added to the core portion (material). In this case, epoxy resin or the like is used as a resin material.

As mentioned above, according to the present invention, because itis arranged that the difference between the relative dielectric constants of the skin portions and the core portion that constitute the wall of the radome be 1.5 or less, the reflection loss of the electromagnetic wave can be lowered over the wide range of the angle of incidence.

Furthermore, according to the present invention, because in the two skin portions or the core portion, or in both the two skin portions and the core portion, is dispersed a material having a relative dielectric constant that is different from that of the portion in which the material is dispersed, the difference between the relative dielectric constants of the skin portion and the core portion can be adjusted to 1.5 or less.

Additionally, one at least of the skin portion and the core portion includes at least one material selected from the group consisting of BaTiO₃, CaTiO₃, MgTiO₃, SrTiO₃, (Zr, Sn) TiO₄, BaTi₄O₉, Ba₂Ti₉O₂₀, (Mg, Ca) TiO₃, Ba(Zr, Ti)O₃, Ba(Mg, Ta)O₃, Ba(Zn, Ta)O₃, BaTiO₄, WO₃, TiO₂, Bi₄Ti₃O₁₂, BaZrO₃, CaSnO₃, alumina, and silicon. At a result, the relative dielectric constant of each of the portions that constitute the wall of the radome can be adjusted as requested, thereby making it possible to produce a radome on which the reflection loss of an electromagnetic wave is small over the wide range of the angle of incidence thereof.

1. A radome having a laminated structure comprising a skin portion and a core portion, wherein relative dielectric constants of the skin portion and the core portion is differ by no more than 1.5.

2. The radome according to claim 1, wherein at least one of the skin portion and the core portion, has dispersed within it a material having a relative dielectric constant different from the relative dielectric constants of the at least one of the skin portion and the core portion in which the material is dispersed.

3. The radome according to claim 1, wherein at least one of the skin portion and the core portion includes at least one material selected from the group consisting of BaTiO₃, CaTiO₃, MgTiO₃, SrTiO₃, (Zr, Sn)TiO₄, BaTi₄O₉, Ba₂Ti₉O₂₀, (Mg, Ca)TiO₃, Ba(Zr, Ti)O₃, Ba(Mg, Ta)O₃, Ba(Zn, Ta)O₃, BaTiO₄, WO₃, TiO₂, Bi₄Ti₃O₁₂, BaZrO₃, CaSnO₃, alumina, and silicon.
